(19) United States
(12) Patent Application Publication
(10) Pub. No.: US 2017/0004135 A1
(43) Pub. Date: Jan. 5, 2017

(54) CONTENT SOURCE THROTTLING IN A SOCIAL NETWORKING SERVICE

(71) Applicant: LinkedIn Corporation, Mountain View, CA (US)

(72) Inventors: Keith O. Langston, Mountain View, CA (US); Chi Chan, Milpitas, CA (US)

(21) Appl. No.: 15/084,780

(22) Filed: Mar. 30, 2016

Related U.S. Application Data
(60) Provisional application No. 62/187,096, filed on Jun. 30, 2015.

(51) Int. Cl. G06F 17/30; H04L 12/58

(52) U.S. Cl. CPC G06F 17/3053; H04L 51/32

(57) ABSTRACT

A system and a method includes determining, with a processor, for each of a plurality of processor-implemented content item sources, an output quality metric based on activity data related to actions accessed from an electronic data storage related to content items previously output by a respective content item source, determining, for each of the ranked lists, based on the output quality metric of the respective content item source, a number of content items of the ranked list eligible for output to a user device, and outputting content items for display on a user interface according to the eligible content items of the ranked lists. Each of the content item sources are configured to output a ranked list of content items stored in the electronic data storage according to a ranking schema different for each of the content item sources.

### RELATED APPLICATIONS

This application claims the benefit of priority to U.S. Provisional Patent Application Ser. No. 62/187,096, filed Jun. 30, 2015, which is incorporated herein by reference in its entirety.

### TECHNICAL FIELD

The subject matter disclosed herein generally relates to throttling content item sources in a social networking service.

### BACKGROUND

Online social networking systems conventionally obtain content items from multiple content item sources. The content items as obtained may then be displayed to users of the social network on a user interface, such as a news stream, dedicated windows or spaces on a visual display, separate windows, and the like. Content item sources may include user profiles and changes thereto stored by the social network, entities that provide sponsored content or databases in which the content items are stored, and organic content recommendation engines, such as engines that provide particular types of content, including job recommendations, recommended connections with members of the social network, and content that other members and users of the social network have found interesting.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social network system, consistent with some examples.

FIGS. 2A and 2B are a simplified illustration of a social network system including content item sources in relation to the feed mixer, in an example embodiment, and the operation of the feed mixer to throttle content item sources.

FIG. 3 is a detailed block diagram of a feed mixer, in an example embodiment.

FIGS. 4A and 4B are simplified depictions of a user interface as provided by a social network system, in an example embodiment.

FIG. 5 is a graphic illustration of a relationship between the selection metric and the value metric, in an example embodiment.

FIG. 6 is a flowchart for throttling content item sources, in an example embodiment.

FIG. 7 is a block diagram illustrating components of a machine, according to some example embodiments.

### DETAILED DESCRIPTION

Example methods and systems are directed to throttling content item sources in an online social networking service. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In various examples of online social networking systems, the sources of content items may provide content items to be displayed on a user interface based on criteria, the combination of which are unique to the content item source or which are not necessarily common to all of the content item sources. Thus, for instance, a sponsored content item source may factor in criteria such as an amount that a sponsoring entity has bid to display a sponsored content item to a user while a job recommendation engine may utilize criteria that focus on a user's qualifications for the job and the user's current employment status. Such diverse content item sources with selection criteria that are specific to the content items provided by the various individual content item sources may contribute to a rich and diverse user experience with the social network.

However, such arrangements may not be sensitive to the quality of the content item sources and the need or desire to balance the display of the content items obtained therefrom appropriately. In particular, if a content item source has relatively poor selection criteria as a first-pass ranker of the content items included therein then the content items provided by the content item source may be of similarly poor quality or relevance to the user of the social networking system to whom the content items are displayed. Furthermore, a single content item source may provide more content items than are necessarily desired without the capacity for the social network provider to understand if the large numbers of content items are desirable because they are highly relevant to the user or undesirable because they are of poor or middling quality, in which case their sheer number may overwhelm other content items in a news feed or may otherwise diminish the experience of the user.

A second-pass ranker may act as a feed mixer to manage the provision of content items from the various content item sources to a user interface of a user device associated with a user of the social networking system. The feed mixer may utilize past activities by members of the social networking system to determine an output quality metric of each of the content item sources. On the basis of the individual output quality metrics, the feed mixer may throttle up or down the various content item sources to increase or decrease the number of eligible content items from each content item source that may be eligible for display on a user device. Thus, relatively high quality content item sources may be accessed for relatively large numbers of content items while relatively low quality content item sources may be accessed for relatively small numbers of content items or no content items at all.

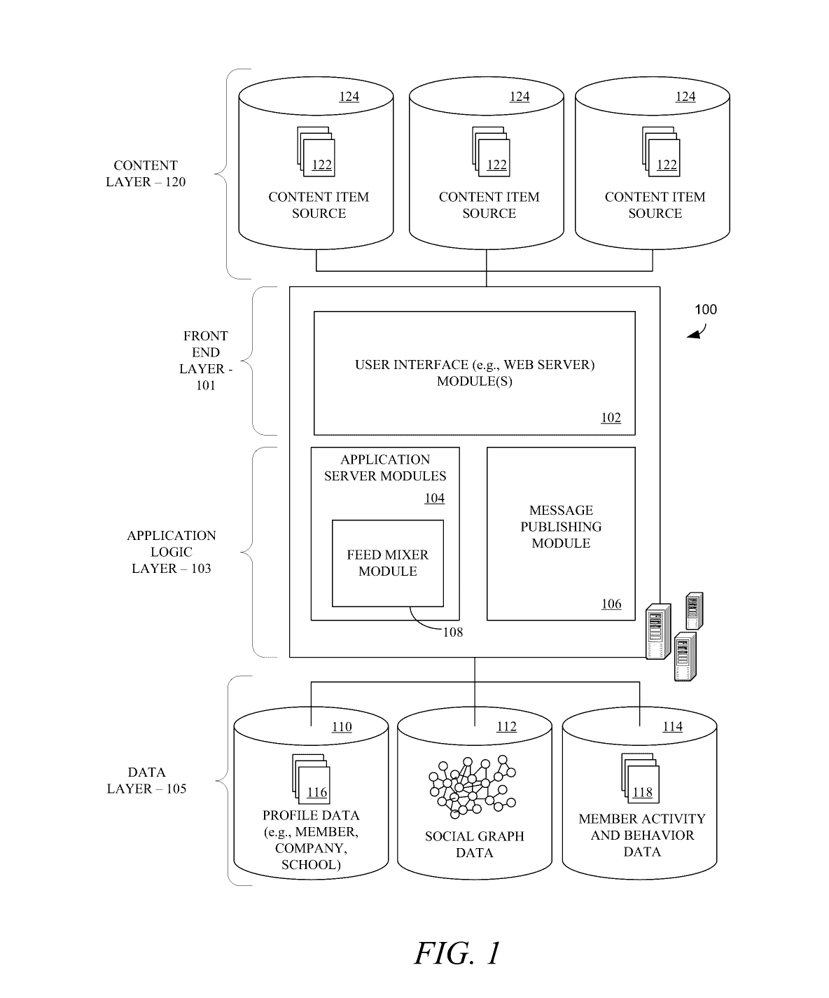

FIG. 1 is a block diagram illustrating various components or functional modules of an online social networking system 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network system 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network system 100 includes a content item publishing module 106, such as may be utilized to receive content, such as electronic messages, posts, links, images, videos, and the like, and publish the content to the social network.

One or more of the application server modules 104, the content item publishing module 106, or the social network system 100 generally may include a feed mixer 108. As will be disclosed in detail herein, the feed mixer 108 may allow for content items from multiple content item sources to be combined into a single feed for transmission to and/or display on a user interface of a member or user of the social network.

The feed mixer 108 may be implemented on a separate server or may be part of a server that provides other portions of the social network system 100. Thus, it is to be understood that while the feed mixer 108 is described as an integral component of a social network, the principles described herein may be applied without the feed mixer 108 being an integral part of a social network or even necessarily utilizing data from a social network if content items 122 are available from alternative sources.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network system 100, including past searches that have been conducted by the feed mixer 108, may be logged as activities 118 in the activity and behavior database 114. Such activities may include search terms, interactions with search results and subsequent engagement with the subject of search results, scores assigned to such search terms, as disclosed herein, communication with others via the social network, engagement with content items posted on the social network, joining groups, following entities, and so forth.

The data layer 105 collectively may be considered a content item database, in that content items 120, including but not limited to member profiles 116, may be stored therein. Additionally or alternatively, a content item layer 120 may exist in addition to the data layer 105 or may include the data layer 105. The content item layer 120 may include individual content items 122 stored on individual content item sources 124. The member profiles 116 and the activities 118 may be understood to be content items 122, while the profile database 110, the social graph database 112, and the member activity database 114 may also be understood to be content item sources 124. Content items 122 may further include sponsored content items as well as posts to a news feed, articles or links to websites, images, sounds, event notifications and reminders, recommendations to users of the social network for jobs or entities to follow within the social network, and so forth.

The social network service may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest. With some examples, the social network service may host various job listings providing details of job openings with various organizations.

Although not shown, with some examples, the social network system 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

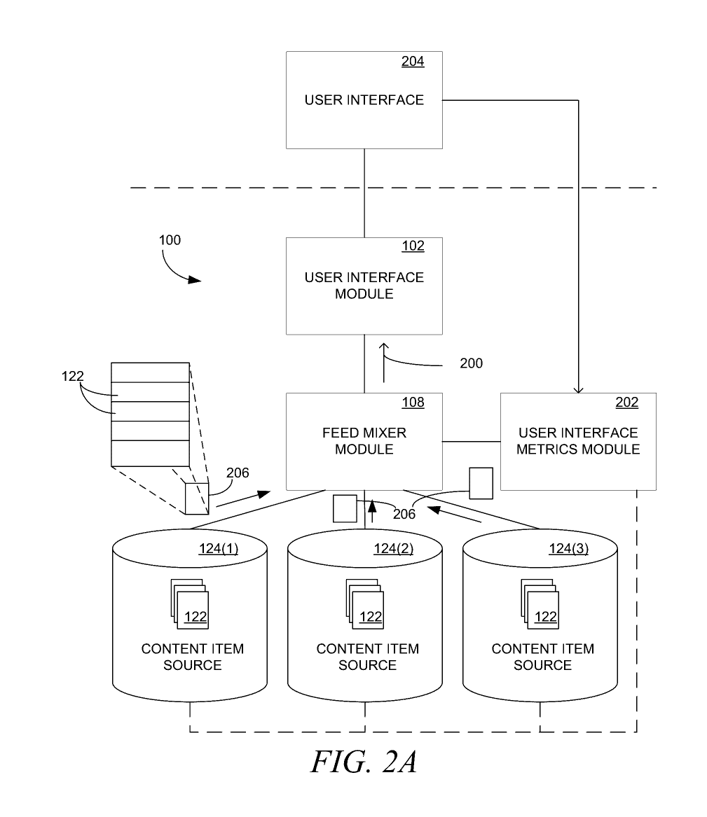

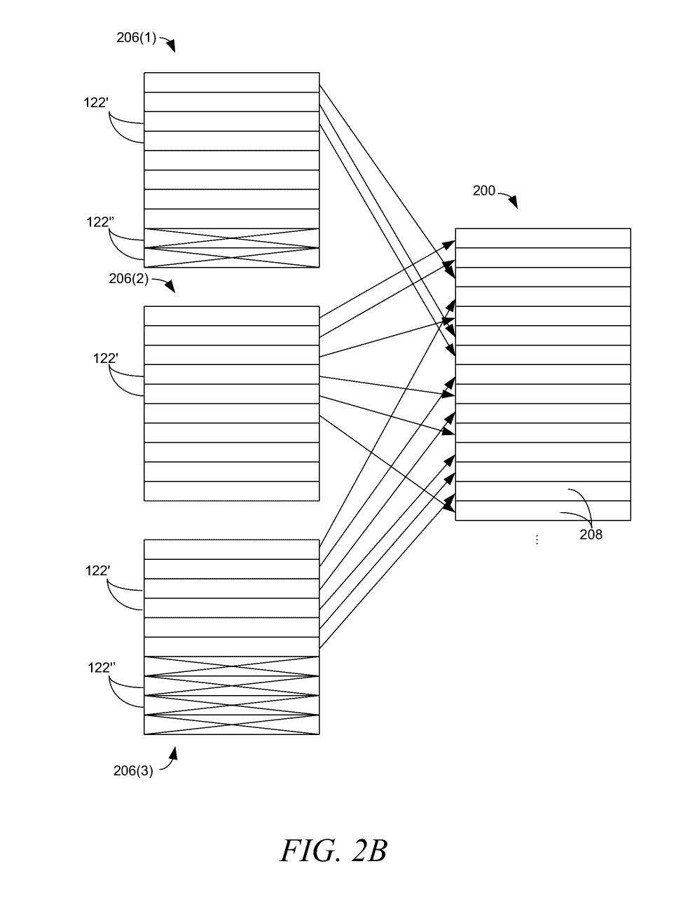

FIGS. 2A and 2B are simplified illustrations of the social network system 100 including the content item sources 124 in relation to the feed mixer 108, in an example embodiment, and the operation of the feed mixer 108 to throttle content item sources 124. As illustrated in FIG. 2A, the social network system 100 allows for the content item sources 124 to be combined into a single feed for transmission to and/or display on a user interface of a user device of a member or user of the social networking system 100. The social networking system 100 further allows for the content item sources 124 to be displayed as push notifications on a user interface. In an example, some or all of the content item sources 124 are implemented as an API, such as an http API.

The content item sources 124 may rank the content items 122 stored therein according to the ranking parameters of the content item source 124. Such content item sources 124 may include content item sources disclosed in U.S. Patent Application Publication No. 2014/0143163, “USER CHARACTERISTICS-BASED SPONSORED JOB POSTINGS”, U.S. Patent Application Publication No. 2014/0143323, “USER CHARACTERISTICS-BASED SPONSORED COMPANY POSTINGS”, and U.S. Patent Application Publication No. 2015/0039406, “INDEPENDENT TARGETED SPONSORED CONTENT MANAGEMENT SYSTEM AND METHOD”, all of which are incorporated by reference herein in their entirety. The content item sources 124 may thus function as first-past rankers of the content items 122 stored therein or obtained thereby.

In various examples, the content item sources 124 provide content items 122 on the basis of a request from the feed mixer 108 for content items 122. In such examples, the feed mixer 108 may request a predetermined number of content items 122 from some or all of the content item sources 124 or may simply request content items 122, in response to which the content item sources 124 may provide as many content items 122 as each content item source 124 deems appropriate given their own respective criteria. In various examples, the content item sources 124 may also provide content items 122 to the feed mixer 108 for provision on a user interface of a user without being prompted by the feed mixer 108. In various examples, such “pushed” content items 122 may be incorporated into a feed or as push notifications or separate messages on the target user's user interface.

The feed mixer 108 may rank the content items 122 provided to the feed mixer 108 by the content item sources 124. As such, the feed mixer 108 may function as a second-pass ranker. Based on the content items 122 as ranked by the feed mixer 108, the feed mixer 108 may produce as output a content item 122 stream 200 that may be an http API or any of a variety of other suitable formats known in the art. The content item stream 200 may be utilized by the messaging publishing module 106 and/or the user interface module 102 to provide the output to the user interface of the user or member.

A protocol may be defined between the feed mixer 108 and the content item sources 124. The feed mixer 108 may utilize the protocol to make requests to the content item sources 124 for ranked content items 122 from some or all of the sources 124. The requests may be according to a conventional http protocol. The content item sources 124 may similarly respond according to a conventional http data transfer.

The content item sources 124 may include or may be modified to include one or more files or programs that allow the ranked content items 122 to be transmitted and formatted according to the protocol. In an example, an object notation standard may be utilized to generate the data transfer of ranked content items 122. In an example, the JavaScript Object Notation (JSON) standard may be utilized. Libraries that may programmatically generate libraries that may read, validate, serialize, and deserialize the data transfer into language specific data structures. In the above example utilizing the JSON standard, the data structures may be Java objects.

As such, the one or more files or programs may include a product specification file that may be incorporated into a trunk directory of one or more of the content item sources 124. Additionally, a project build file may likewise be incorporated. A common key, in the above example a JSON coordinate, may be utilized between the product specification file and the project build file.

A user interface metrics module 202 may identify content items 122 that produce or do not produce a user interaction with the content item 122 when displayed on a user interface 204 of a user device. In various examples, if a user interacts with a content item 122 as displayed on the user interface 204, such as by clicking a link, sharing the content item 122, commenting on the content item 122, and so forth, the user interface metrics module 202 variously either receives the interaction directly or receives an indication of the interaction. For instance, receiving the interaction itself may be to receive the text of a comment that was entered while receiving an indication of the interaction may be to receive a notice that a comment was entered without receiving the comment itself. The user interface metrics module 202 is optionally coupled to the content item sources 124 and may save the interactions as received, such as in the activities database 114.

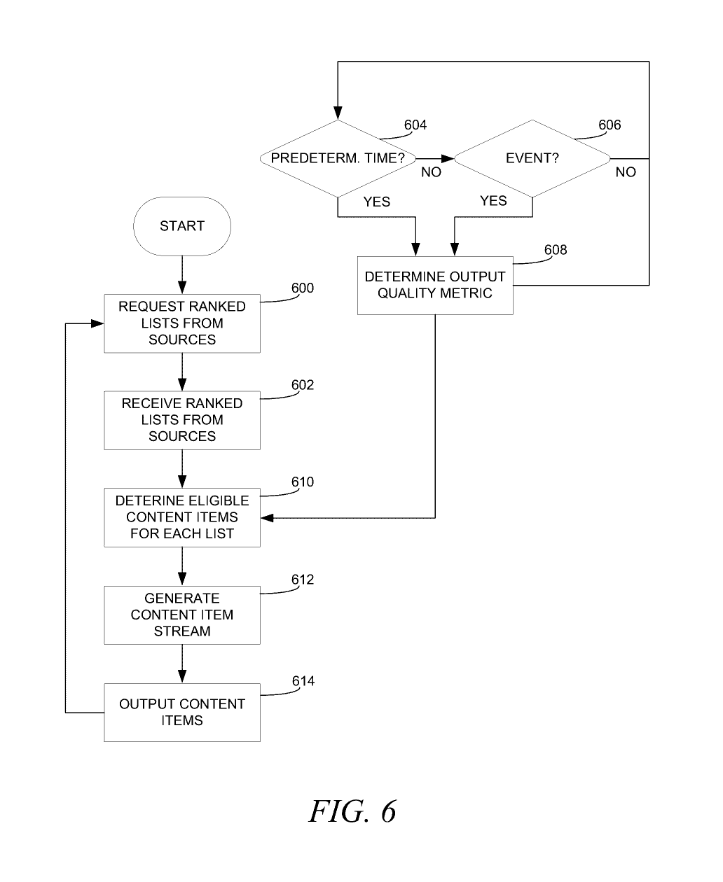

On the basis of the output of the user interface metrics module 202, the feed mixer module 108 may “throttle” or otherwise adjust the number of content items 122 that are used from the various individual content item sources 124. The process is further illustrated as a flowchart in FIG. 6. Throttling of the content item sources 124 by the feed mixer module 108 exists outside of the context of the utility value for individual content items 122 that is determined herein and which may factor in a quality of the output of the content item source 124 from which the content item 122 was provided. As will be disclosed herein, a content item source 124 may be throttled before utility values are considered. As such, while various examples include calculating and utilizing the utility value of individual content items 122 for determining where to place the content item 122 in a feed, the throttling of content item sources 124 may be implemented without then proceeding calculate utility values. Rather, content items 122 that are still available to the feed mixer module 108 after throttling the content item sources 124 may be positioned on a feed according to any suitable mechanism for placing content items 122 in the feed or may be presented as push notifications, as appropriate.

As illustrated, each content item source 124 provides a ranked list 206 of content items 122 to the feed mixer module 108. It is to be understood that any suitable number of content items 122 may be included in each list 206, including at least one content item 122. As disclosed herein, while the ranked list 206 may include an actual score for each of the content items 122 in the list, for the purposes of throttling only the relative position of each of the content items 122 of the list 206 may be pertinent.

For each of the ranked lists 206, the feed mixer 108 determines a number of content items 122 that are eligible for inclusion in the stream 200 without respect to whether or not the eligible content items 122 actually are ultimately included in the stream. The feed mixer 108 determines eligibility based on an output quality metric of the content item source 124 that generated the ranked list 206. In various examples, the output quality metric is or is based on engagement values, as disclosed herein. More generally, the output quality metric is based on a rate at which activities 118 indicate users engage with content items 122 generated by a particular content item source 124 determined in the same or similar manner to that of the engagement values. While an example of the determination of the output quality metric for the content item sources 124 will be disclosed, it is to be understood that the principles disclosed with respect to the engagement values may be applied in general to the determination of the output quality metric for the content item sources 124.

In an example, the output quality metric for a content item source 124 is determined by comparing the rate at which users of the social networking system 100 engage with the content items 122 provided by the content item source 124 against threshold values. The feed mixer 108 accesses the activity database 114 for activities 118 conducted with content items 122 from the content item source 124 over a predetermined time period. The predetermined time period may, in various examples, be a defined amount of time, such as days, weeks, or months, or may be event based, such as the start of operation of the content item source 124 or the implementation of an update to the content item source 124. The activities 118 accessed may be all of the activities 118 related to the content item source 124 over the predetermined time period or may be a representative, random statistical sample of the activities 118.

The output quality metric may be determined based on a ratio of activities 118 with affirmative user engagement with content items 122 from the content item source 124 with the number of times the content items 122 were displayed on the user interface 204. The output quality metric may be weighted based on a relative quality of the activities 118. Thus, in an example, an activity 118 that is a user comment on a content item 122 may be worth twice a user activity 118 that is a click on a link, and so forth, depending on the priorities of the administrators of the social networking system. Thus, the feed mixer 108 may tally up the weighted value of the activities 118 that indicate user engagement with the content items 122 from a content item source 124 and divide that value by the total number of times those content items 122 were presented on user interfaces 204 to obtain the output quality metric.

The output quality ratio may be separately determinable a single content item source 124 for different circumstances or based on the activities 118 of different users, as appropriate. For instance, the output quality metric for a content item source 124 may be calculated separately for different types of members based on distinctions between their profile data 116. In an example, a content item source 124 that provides job recommendations may be assessed separately for members who have profile data 116 indicating that they are looking for a job and members who have profile data 116 indicating that they are not looking for a job. Thus, the content item source 124 for providing job recommendations may have a first output quality metric when the feed mixer 108 is generating a stream 200 for presentation to a member who is looking for a job and a second, different output quality metric for generating a stream 200 to a member who is not looking for a job.

Further, while the example of the jobs content item source 124 is presented with respect to a characteristic of the content item source 124 itself in relation to profile data 116, different output quality metrics may be calculated based on the type of member without respect to the characteristics of the content item source 124. Thus, for instance, content item source 124 may have different output quality metrics for content item sources 124 when the content items 122 are selected for being position on a user interface of a personal computer or laptop computer or other computing device that is not conventionally utilized while the user is mobile, or on a user interface of a conventionally mobile device, such as a smartphone, personal digital assistant (“PDA”), table computer, and the like. By way of further example, members who are relatively heavy users of the social networking system 100, e.g., members who access the system on a roughly daily basis, than for members who are relatively light users of the social networking system 100, e.g., members who access the system on a roughly weekly or monthly basis. How use levels are differentiated and broken down may depend on the characteristics of the social networking system 100 and what tends to constitute heavy and light users.

Having determined the output quality metric for a content item source 124, the feed mixer 108 then determines if the content item source 124 should be throttled. As generally disclosed herein, throttling is done at and by the feed mixer 108 by identifying a maximum number of eligible content items 122 that may be used from the ranked list 206 provided by the content item source 124. Thus, in such examples, the content item source 124 provides the full ranked list 206 and the feed mixer 206 then disregards as particular number of ineligible content items 122 on the list 206 if the content item source has been throttled. However , it is to be understood that, alternative, the feed mixer 108 may instruct the content item source 124 to include in the ranked list 206 not more content items 122 than are permitted under the throttling of the content item source 124. Thus, in such an example, the content item source 124 is throttled by transmitting a reduced ranked list 206 in the first instance.

In various examples, the output quality metric is compared against one or more threshold quality metrics or other threshold values. In various examples, the threshold quality metrics include multiple individual threshold values that, when the output quality metric falls below those individual threshold values, result in a reduction in the eligible number of content items 122 of the ranked list 206 provided by the content item source. This example will be illustrated herein, but it is to be understood that the comparison of the output quality metric to the threshold quality metric may be based on any mathematical or statistical relationship between those two metrics that may be implemented as appropriate. Thus, an alternative implementation may result in throttling if the output quality metric exceeds the threshold quality metric if the choices made in the particular implementation results in a low number output quality metrics being desirable.

In an illustrative example, the threshold quality metric has a first threshold value or standard quality metric of 0.04. If the output quality metric is at or above the standard quality metric then the content item source 124 is not throttled but below which one of the content items 122 of the ranked list 206 becomes ineligible for inclusion by the feed mixer 108 in the stream 200, whatever that content item's apparent merits. In such an example, the threshold quality metric has a second threshold value of 0.035, a third threshold value of 0.03, a fourth threshold value of 0.025, and a fifth threshold value or minimum quality metric of 0.02. If the output quality metric is less than the first threshold value but equal to or greater than the second threshold value then one of the content items 122 of the ranked list 206 becomes ineligible for inclusion in the stream 200. If the output quality metric is less than the second threshold value but equal to or greater than the third threshold value then two of the content items 122 of the ranked list 206 becomes ineligible for inclusion in the stream 200. If the output quality metric is less than the third threshold value but equal to or greater than the fourth threshold value then three of the content items 122 of the ranked list 206 becomes ineligible for inclusion in the stream 200, and so forth. If the output quality metric is less than the minimum threshold metric then all of the content items 122 of the ranked list 206 become ineligible for inclusion in the stream 200.

To continue with the illustrative example, as disclosed above, the threshold quality metric is applied to all of the output quality metrics of the content item sources 124. Alternatively, various content item sources 124 may have different threshold quality metrics or may have the threshold quality metric adapted to their particular circumstances. Thus, while a first, conventional content item source 124 may have the threshold quality metric disclosed above applied to its output quality metric, a second, critical content item source 124 may have a different threshold quality metric that may vary in the individual threshold values, that may not have a cutoff below which the number of eligible content items 122 go to zero, and any of a variety of other differences or changes.

FIG. 2B illustrates an example application of the threshold quality metric to the output quality metrics of the content item sources 124 and the generation of the stream 200 by the feed mixer 108. A first content item source 124(1) has an output quality metric of 0.031, a second content item source 124(2) has an output quality metric of 0.053, and a third content item source 124(3) has an output quality metric of 0.022. Upon receiving the ranked lists 206, each of ten content items 122, from the content item sources 124, the feed mixer 108 determines a number of content items from the individual ranked lists that are eligible for inclusion in the stream 200. Thus, in the illustrative example, the first ranked list 206(1) from the first content item source 124(1) has two ineligible content items 122 and eight eligible content items 122 as 0.031 is less than the second threshold value but greater than the first threshold value. The second ranked list 206(2) from the second content item source 124(2) has no ineligible content items 122 and ten eligible content items 122 as 0.053 is greater than the first threshold value. The third ranked list 206(3) from the third content item source 124(3) has four ineligible and six eligible content items 122 as 0.022 is less than the fourth threshold value but greater than the fifth threshold value.

The feed mixer 108 makes the highest ranked content items 122 of each ranked list 206 the eligible content items 122′ of that list 206 and the lowest ranked content items 122 the ineligible content items 122″ of that list 206. Thus, in the illustrated example, the first ranked list 206(1) has the top eight content items 122′ eligible and the bottom two content items 122″ ineligible. Alternative examples may make provide for any suitable considerations for which content items 122 are eligible or ineligible within a ranked list 206 with the provision that the number of eligible and ineligible content items 122 be implemented within the each list as appropriate.

The feed mixer 108 then populates the individual positions 208 within the stream 200 as appropriate from the eligible content items 200. The population of the stream 200 may be according to the principles disclosed herein with respect to the feed mixer 108. Thus, to populate the stream 200 the feed mixer 108 may determine a utility value for each of the eligible content items 122′ and populate the stream 200 according to those utility values. Additional or alternative mechanisms and considerations for populating the stream 200 may be implemented as desired and appropriate. However, in various examples, ineligible content items 122″ are not included in the stream 200 by the feed mixer 108.

As disclosed herein, the output quality metric may be determined for a content item source 124 variously on a periodic basis and/or on an event basis. The periodic basis may be to specify that each content item source 124 be assessed for its output quality metric every week, every two weeks, every month, or according to an alternative time period as desired or appropriate. On an event basis, a content item source 124 may have its output quality metric determined upon or a predetermined time following an event, such as the content item source's 124 inclusion in the social networking system 100, an update to the content item source 124 being implemented, and so forth. For events, prior to the accumulation of sufficient activity data 118 following the event, the content item source 124 may operate with a provisional output quality metric that variously allows all content items 122 from the content item source to be eligible for display or that allows a reduced number of content items 122 to be eligible, as desired.

The various time periods may be extended based on the history of the content item source 124. Thus, if a content item source is relatively mature then the predetermined time period may be extended. For instance, if a content item source 124 has been operating for one year or more then the predetermined time period may be extended from two weeks to one month for that content item source 124. Further, various events, such as an update to a mature content item source 124, may be assessed as being minor, in which case a new output quality metric may not be necessary on an event basis and rather may await a scheduled, periodic update.

If a content item source 124 has an output quality metric that falls below the minimum quality metric and, as a result, the feed mixer 108 makes all of the content items 122 from that content item source 124 ineligible for display, then the content item source 124 may not have the further opportunity to generate more activity data 118 to receive an output quality metric sufficiently high to make content items 122 from that source 124 eligible for display. In an example, the feed mixer 108 may periodically set a provisional output quality metric for a content item source 124 about the minimum quality metric to allow content items 122 from that source 124 to be displayed to members and generate activity data 118 that may be utilized in updating the output quality metric for that content item source 124. Alternatively, a content item source 124 that ever receives an output quality metric below the minimum quality metric may require an event, such as an upgrade or other change to the content item source 124, before the output quality metric may be reset, whether normally or provisionally.

The social network system 100 may provide content items 122 to the user interface 204 in a feed mixing mode and a testing mode. The social network system 100 may switch between modes from time to time and from user to user. Thus, some users may receive content items 122 as provided by the feed mixer 108 and other users may receive content items 122 with the operation of the feed mixer 108 reduced or disabled altogether. In the testing mode the impact of the operations of the content item sources 124 and their function as first-pass rankers may be assessed using the user interface metrics module 202 by varying the display of content items 122 on the user interface 204. In the federating mode the feed mixer 108 may utilize the assessments provided by the user interface metrics module 202 to determine the relative effectivity of the content item sources 124 at assessing the content items 122 stored thereon and adjust the resultant display of content items 122 on the user interface 204.

The testing mode may be selectively applied to particular components of the social network system 100 to obtain particular information, as disclosed herein. In various examples, individual content item sources 124 may be selectively placed in testing mode and their output randomly or varyingly presented to the user while the output of other content item sources 124 may be presented to users according to federation policies implemented by the feed mixer 108. In such examples, newly added or modified content item sources 124 may be dynamically tested and their results compensated for, as disclosed herein, while other content item sources 124, such as those that have already been assessed in the testing mode and incorporated into the federation protocol as disclosed herein may operate statically outside of the testing mode.

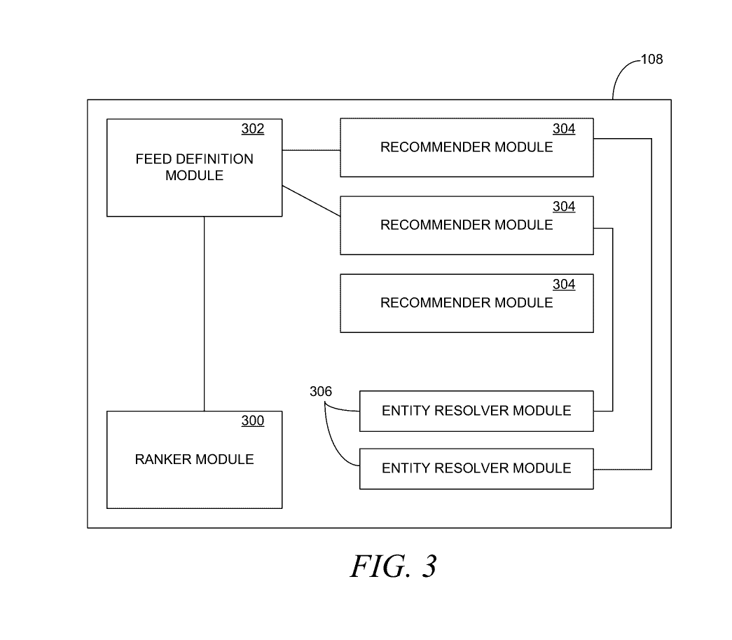

FIG. 3 is a detailed block diagram of the feed mixer 108, in an example embodiment. In such an example, the feed mixer 108 is a separately implemented http server. The feed mixer 108 includes a ranker module 300, a feed definition module 302, recommender modules 304, and entity resolver modules 306. The some or all of the various modules 300, 302, 304, 306 may be separately implemented files operated on a processor of the server or may be divided between and among multiple servers.

The ranker module 300 may obtain collections of content items 122 retried from the content item sources 124 as specified by the feed definition module 302. The ranker module 300 may de-duplicate the content items 122 from the various sources 124, may perform a second-pass or global ranking of the content items 122, and may provide the result as the output of the feed mixer 108.

The feed definition module 302 may provide the content items 122 or cause the content items 122 to be provided to the ranker module 300. The feed definition module 302 may map an identifier of the feed to be output on to the recommender modules 304 and the ranker module 300. Thus, content items 122 may be identified in the recommender modules 304 and provided to the ranker module 300 based on the identifier.

The recommender modules 304 may define a mapping between the content item sources 124 and a recommender that will provide content items 122 based on a request for content items 122 to be provided and one or more of the resolver modules 306. The resolver modules 306 may optionally covert a format of content items 122 as obtained from the content item sources 124 to a common format.

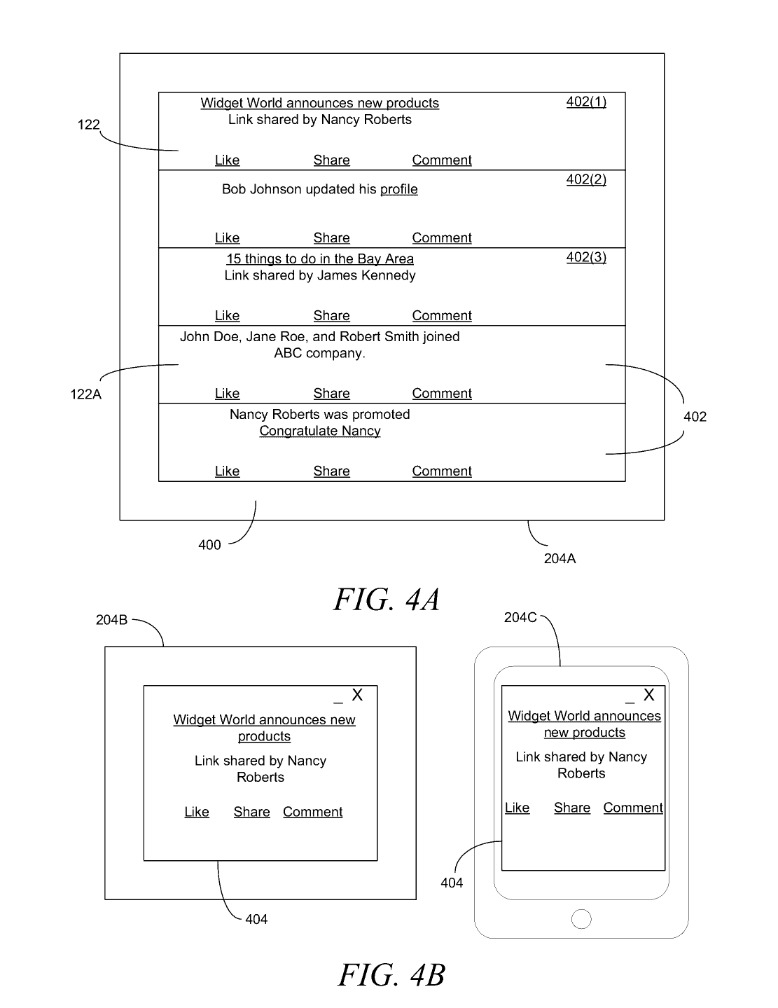

FIGS. 4A and 4B are simplified depictions of a user interface 204 as provided by the social network system 100, in an example embodiment. The user interface 204A of FIG. 4A includes a news feed 400 that includes multiple individual positions 402 arranged, in this example, in a vertical list with a first position 402(1) at the top and lower positions sequentially down the list. Each position 402 includes space to display content related to the content item 122; in various examples, the content item 122 itself may be displayed, for instance if the content item 122 is a link or a renderable image, or data relating to the content item 122 may be displayed, such as if the content item 122 needs to be reformatted for the user interface 204A or the circumstances in which the user interface 204A is being displayed. It is to be recognized that the user interface 204A is provided for the purposes of an example and that many additional configurations of user interfaces 204A are contemplated and may be utilized consistent with the principles described herein.

The social network system 100 may operate in the testing mode described above by obtaining content items 122 from the content item sources 124 and displaying the content items 122 on the user interface 204A without respect to the feed mixer 108. As such, the content item sources 124 may function in their first-pass ranker mode without second-pass ranking provided by the feed mixer 108. In various examples, the content items 122 may still pass through the feed mixer 108, as illustrated in FIG. 2, but the second-pass ranking function of the feed mixer 108 may be disabled.

In an example, at least one of the feed mixer 108 and the message publishing module 106 call to a content item source 124 to obtain at least one content item 122 for display on the user interface 204A. The content item 122 may then be displayed in a particular position 402 of the news feed 400. In an example, the position 402 is randomly selected or pseudo-randomly selected. In an example, the content item 122 may be displayed on multiple user interfaces 204A corresponding to multiple different users. In such an example, a given content item 122 may be iteratively moved from position 402 to position 402 when it is displayed on multiple user interfaces 204A so as to sequentially be positioned in a variety of positions 402 over time. Additional content items 122 may be obtained from various content item sources 124 and positioned randomly or varyingly in positions 402 in the various user interfaces 204A so as to fill out the positions 402 of the news feed 400.

In addition to the content items 122 themselves, the content item sources 124 may provide the first-pass ranking details of each content item 122 to the user interface metrics module 202. It is noted and emphasized that, in the testing mode, the content items 122 as provided may not necessarily be placed according to the first-pass ranking provided by the content item sources 124. However, the data from the first-pass ranking may be utilized by the user interface metrics module 202 to assess the quality of the first-pass ranking of the various content item sources 124.

As displayed on the various user interfaces 124, the content items 122 may be interacted with, as disclosed herein. The user interface metrics module 202 may note those interactions for each content item 122 and/or the lack of interactions thereof. In various examples, the user interface metrics module 202 may also optionally note the position 402 in which the content item 122 was displayed when it was or was not interacted with. It is noted that the position 402 may be superfluous if the content item 122 is displayed randomly or sequentially varying on a relatively large number of user interfaces 204A.

For a given content item 122 as displayed on user interfaces 204A, the user interface metrics module 202 may note the rate at which the content item 122 was the subject of a user interaction in comparison with the first-pass ranking that the content item source 124 provided for the content item 122. The user interface metrics module 202 may compare those figures with the expected interaction performance of a content item 122 that has been placed in the positions in which the given content item 122 has been placed.

The various content item sources 124 may perform first-pass ranking and other assessments according to schemas that are not consistent among all of the content item sources 124. Thus, in an example, a first content item sources 124 may operate according to a first selection schema that seeks to determine a selection metric indicative of the likelihood that a given content item 122 will be interacted with by a user. The first content item source 124 may further operate according to a first value schema that seeks to determine a value metric of a content item 122 as if the content item 122 were a piece of sponsored content. It is noted that, if the content item 122 is, in fact, a piece of sponsored content, and the content item source 124 is, for instance, an advertising index, the actual bid for the sponsored content item may be the value metric. The value metric may, in various examples, be a value in a currency, such as United States dollars or other national or international currency.

In contrast to the first content item source 124, the second content item source 124 may operate according to a second selection schema different from the first selection schema and a second value schema different from the first value schema. Most generally, selection schemas and value schemas may differ between content item sources 124 if the same content item 122 receives a different selection metric when run against the first selection schema and the second selection schema. It is to be noted, however, that most or all content items 122 may only be run against one selection schema and one value schema because content items 122 may tend only to be stored in one content item source 124.

For instance, in the illustrative example, for a sample content item 122, the content item source 124 may provide a first-pass rank that suggests that the content item 122 is at the seventy-fifth (75th) percentile for likely user interaction and should optimally be placed in the third position 402(3). In the example, the user interface metrics module 202 has previously determined that, on average, a content item 122 randomly placed in the news feed 400 that is expected to be in the seventy-fifth percentile and/or is placed in the third position 402(3) is interacted with by a user, on average, eleven (11) percent of the time. In the illustrative example, the user interface metrics module 202 determines that, overall, the sample content item 122 is interacted with thirteen (13) percent of the time both overall and in the third position 402(3).

On that basis, the user interface metrics module 202 may determine that the content item source 124 that provided the content item 122 understates or underestimates the likely performance of the content items 122 it ranks. The user interface metrics module 202 may perform the testing mode analysis on multiple content items 122 from multiple content item sources 124. Ultimately, the user interface metrics module 202 may characterize some or all of the content item sources 124 according to the degree by which the content item sources 124 overestimate or underestimate the likely user interaction with the content items 122 the content item source 124 provides. Thus, for the content item source 124 that provided the sample content item 122 referenced above, the user interface metrics module 202 may utilize dozens or more content items 122 from the content item source 124 to determine that the content item source 124 consistently underestimates the user engagement rate for the content items 122 it provides by two (2) percentage points. Other content item sources 124 may be determined to overestimate by various percentages or be essentially accurate in their assessments.

In the federating mode, the feed mixer 108 may obtain, from the various content item sources 124, content items 122 and an associated selection metric and an associated value metric for each content item 122. The feed mixer 108 may request a predetermined number of content items 122 from some or all of the content item sources 124 or the content item sources 124 may individually determine how many content items 122 to send to the feed mixer 108. It is to be further recognized that the content item sources 122 may, at least initially, transmit a list or index of content items to the feed mixer 108 at least until the content items 122 are selected by the feed mixer 108 for display on the user interface 204A, upon which point the content items 122 themselves may be provided.

The feed mixer 108 may further obtain, from the user interface metrics module 202, indications of the interactions with the content items 122 from the various content item sources 124. The indications of the interactions may be on the basis of individual content items 122 that have been tested in the testing mode or on the basis of complete content item sources 124 that have been tested in the testing mode.

The feed mixer 108 may determine an engagement value for each of the content items based on the data from the user interface metrics module 202. The engagement value may be representative of the inherent value of the content itself to the social network without respect to any money the content item 122 may actually earn for the social network system 100. Put another way, the engagement value may reflect the overall value to the social network of having good content to drive traffic to the social network without respect to directly making money off of that content.

In an example, the inherent value represented by the engagement value may vary, at least in part, based on either the user from whom the content item 122 was received or to whom the content item is to be displayed. Thus, certain content items 122 may have a higher engagement for certain types of users than other types of users. The feed mixer 108 may adjust the engagement value for a content item 122 based on user profile data 116 and activities 118 for the user to whom the content item is displayed. Thus, for instance, the engagement value for a content item 122 received from a CEO may be doubled relative to the engagement value for a content item 122 received from a non-managerial employee of the same company.

If the user interface metrics module 202 provided data for the particular content item 122 then the engagement value may be based only on the data related to that content item 122. If the user interface metrics module 202 provided data for the content item source 124 then all of the content items 122 from that source 124 may have an engagement value determined based on the same factors.

The engagement value may be the equivalent to a monetary value that, in essence, adjusts the selection metric and value metric of the content item 122 to account for the overestimation or underestimation of the likely interaction or value of the content item 122 by the selection and value schemas of the content item source 124. Thus, for instance, in the above example, the feed mixer 108 may determine that the value of a content item 122 from the sample first content item source 124 described above should be increased by $0.005 to account for the fact that the content items 122 from that source routinely underestimates the user interaction with the content items 122 by two (2) percentage points.

It is to be emphasized that the engagement and monetary values are, in fact, unit-less and may have any suitable numerical value. For the purposes of explanation in the disclosure herein, the values disclosed herein have been normalized to an equivalent monetary value. Thus, in a simplified description for the purposes of illustration, the engagement value is in essence described as being calculated as an equivalent monetary value and combined with an actual monetary value to create the utility value of equivalent monetary value. However, it is to be noted and emphasized that the utility value does not need to represent an equivalent monetary value and rather can be directed at any “value” that administrators of the social network may have.

Thus, while the steps described herein may relate to bringing the engagement value into line with the monetary value, the opposite may readily be implemented to bring the monetary value in alignment with the engagement value according to the same principles. Thus, in a simplified example, one user interaction with a content item may have an engagement value of “1”, and monetary values may, for instance, be multiplied by a factor of twenty (20); i.e., a monetary value of $0.005 is the equivalent to one interaction. It is to be readily understood that any suitable values value ranges may be implemented.

As such, the utility value may express a propensity for an associated content item to lead to any outcome that has value to the social network. In an example, the utility value may be tied to a number of “down-stream” interactions that may stem from an initial interaction with a content item. A down-stream interaction may stem from, for instance, a member selecting a link for a content item as the initial interaction, and any subsequent selections of links or comments and the like on the webpage that was linked to would be a down-stream interaction. The relative value of down-stream interactions may be identified based on social network policies in relation to the value of sponsored content items and implemented according to the principles described herein. Further examples of the actual policy or objective of the utility value, such as growth of the membership of the social network, may similarly be implemented according to these principles. As such, feed mixer 108 may be sensitive to the impact on those objectives that the changes to the initial rankings of the content item sources may cause and adjust the changes accordingly.

The user interfaces 204B, 204C of FIG. 4B depicts a push notification 404 of a content item 122 as provided by the federator module 108. As described above, the user interface 204A includes the feed 400, in which the federator module 108 transmits a command to individual content item sources 124 to provide content items 122 for display on the user interface 204A according to the mechanisms disclosed herein. Thus, the feed 400 is, in such examples, generated according to the command of the federator module 108.

By contrast, the user interfaces 204B, 204C include a push notification 404 of a single content item 122 provided by one content item source 124. The push notification 404 exists outside of the context of the feed 400, as illustrated as a “popup” window or screen in the user interfaces 204B, 204C. In various alternative examples the push notification 404 may be integrated into the user interfaces 204B 204C as a bar or window that may exist separate from but in the same screen as the feed 400.

The user interfaces 204B, 204C are user interfaces presented on different user devices. In an example, the user interface 204B is presented on a personal computer, such as a work station, a desktop computer, a laptop computer, or other computing device conventionally referred to as a personal computer or which is not otherwise considered to be readily usable as a “mobile device”. The user interface 204C is presented on what is conventionally referred to as a mobile device, such as a smartphone, a tablet computer, a media player, a personal digital assistant (“PDA”) and the like. It is to be recognized and understood that any of a variety of computing devices may be categorized according to the “personal computer” and “mobile device” classification as appropriate and that additional classifications may be implemented according to the principles disclosed herein.

As will be disclosed in detail herein, the federator module 108 may select, for one member associated with both user interfaces 204B, 204C, a content item 122 as provided by the content item sources 124 based, at least in part, on a suitability of the content item 122 for the particular user interface 204B, 204C and associated user device type on which the push notification 404 is to be displayed. While in various circumstances the user device type may not matter for which content item 122 is to be displayed as a push notification 404, in other circumstances the federator module 108 may select a first content item 122 for display to the member on the user interface 204B but a different, second content item 122 for display to the same member on the user interface 204C.

As will be disclosed in detail herein, individual content item sources 124 are configured to provide individual content items 122 to the federator module 108 without prompting from the federator module 108. Rather, the federator module 108 occasionally receives a content item 122 from a content item source 124 according to selection criteria of the content item source 124 itself and then decides, according to the criteria disclosed herein, whether or not to display the content item 122 as received as a push notification 404 on the user interface 204B.

In an example, the content item sources 124 generate content items 122 for the push notification 404 according to the same mechanisms provided for supplying multiple content items 122 for provision to the feed 400. Thus, some or all of the content item sources 124, according to their individual selection metrics, identify a content item 122 that may be of interest to a member associated with the user interface 204B or may be likely to result engagement by the member. The individual content item sources 124 then provide their individual content items 122 to the federator module 108 to generate a utility value according to the mechanisms disclosed herein, including adjustments for the quality of the individual content item source 124 from which an individual content item 122 was provided.

In various examples, the content item sources 124 provide their content item 122 for a push notification in conjunction with other content item sources 124, e.g., on a set schedule or based on a condition, such as the member logging in to the online social network system 100. Additionally or alternatively, the content item sources 124 may provide content items 122 according to asynchronous conditions, such as in the event that the content item source 124 identifies, in the course of other operations, a content item 122 that may be suitable for the member. Thus, the federator module 108 may receive multiple content items 122, one from each content item source 124, as potential push notifications 404 synchronously, such as simultaneously or essentially simultaneously, or may receive single content items 122 from single content item sources 124 asynchronously. In the first case, the federator module 108 may select one content item 122 from among the pushed content items 122. In either case, the federator module 108 may determine if any content item 122 is presented as a push notification 404 based on the determined utility value for the content item 122 in comparison with other utility values of the other content items 122 and/or a threshold utility value that may be met to display any content item 122 as a push notification 404 at all. These operations are discussed in detail in FIG. 6.

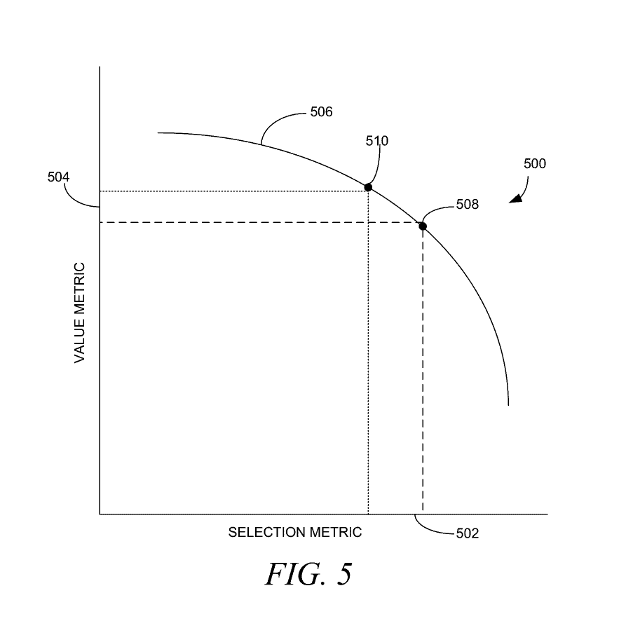

FIG. 5 is a graphic illustration 500 of the relationship between the selection metric and the value metric, in an example embodiment. The x-axis 502 depicts the selection metric, such as the number of user interactions with a content item, while the y-axis 504 depicts the value metric, such as the value of the content item 122 if it were a piece of sponsored content. The curve 506 reflects how changes in the selection metric are reflected in the changes in the value metric and, as a consequence, the engagement value of the content item 122. According to this curve, increasing the selection metric by two (2) percentage points from a first point 508 to a second point 510 may produce the $0.005 engagement value referenced above.

The feed mixer 108 may then generate a utility value for each of the content items 122. The utility value reflects an engagement component and a monetary component. The engagement component is, in an example, comprised of the selection metric multiplied by the engagement value. The value component is, in an example, comprised of the value metric. The engagement component and the value component are, in an example, added together to obtain the utility value. The utility value may represent a normalized value for the content item 122. In various examples, the federator module obtains a utility value for each of the content items obtained from the content item sources 124.

In an example, the utility value will depend on a status of the content item 122 as organic content or sponsored content. The utility value of a sponsored content item may be the engagement component (e.g., the engagement value multiplied by the selection metric) added to the value metric. The value metric for the sponsored content item may be a bid that the sponsoring entity has paid or will pay for the sponsored content item multiplied by the selection metric. In an example, the value metric is thus computed by multiplying the estimated interaction rate for the sponsored content item by the amount of money the sponsoring entity promised to pay every time the sponsored content item is selected by a user. Thus, the utility value for a sponsored content item would be the sum of the expected monetary value of the sponsored content item and the engagement value of the sponsored content item. Put another way, the value of a sponsored content item may be realized in both the ability of the content item 122 to drive user engagement with the social network and the ability of the content item 122 to directly generate revenue.

The utility value of an organic or unsponsored content item, on the other hand, would, in the above example, be based entirely on the ability of the content item 122 to generate engagement with the social network. Thus, the utility value for the organic content item would be only the engagement component (the engagement value multiplied by the selection metric). Thus, it may be discerned that a piece of organic content that drives a great deal of user engagement may have a higher utility value than a piece of sponsored content that that drives relatively little user engagement. Further, a piece of sponsored content that has the same or similar user engagement as an organic content item would have the higher utility value because of the monetary component; all other things being equal, the utility value for a content item 122 that is sponsored would be higher than the utility value of a sponsored content item 122 that is organic.

The feed mixer 108 may thus, in essence, establish a normalized, monetary value for each of the content items 122 it receives for display on the news feed 400 of the user interface 204. In so doing, the feed mixer 108 may both consistently establish the relative value of the content items 122 it receives, regardless of the first-pass ranker schemas utilized by the content item sources 124, and provide a framework by which the value of a sponsored content item may be compared against an organic content item and vice versa. Thus, both the value of the organic content items may be quantified and organic content items may be accurately positioned relative to sponsored content items on the news feed 400.

In particular, the feed mixer 108 may include, as part of the stream 200, the relative utility values of the content items 122 to the user interface module 102. Alternatively, the feed mixer 108 may simply order the content items 122 within the stream 200 according to their respective utility values. The user interface module 102 may then cause the content items 122 to be sequentially placed in the positions 402, at least in part according to their utility values. Thus, in an example, the highest utility value may be positioned in the first position 402(1), the second highest utility value in the second position 402(2), and so forth. Alternatively, additional factors may be implemented in order to meet certain conditions.

The conditions may, in various cases, specify displaying sufficient sponsored content items to generate a maximal amount of revenue while maintaining user engagement, in the form of interactions with the content items above a predetermined threshold. Thus, the sum of the engagement components of some or all of the content items 122 that may be displayed over a period of time may be plotted against the sum of the value components of the content items 122 that may be displayed over a period of time. In selecting the content items 122 for the stream, the feed mixer 108 may select content items with sufficiently high engagement components to maintain the desired user engagement and then, among that population, select the content items 122 with the highest value component.

The above example is simplified and it is to be understood that multi-objective optimization techniques may be applied to the population of content items 122 as appropriate. The constraints of the multi-objective optimization may be applied separately to different types of users depending on the activities 118 conducted by the individual users. Thus, certain users may be relatively more likely to select sponsored content items than other users. Those users may be presented with more sponsored content items than other users, thereby potentially increasing both the value metric, as sponsored content may be directed to the users most likely to select the sponsored content and thus provide the revenue, as well as engagement, as more scope may thus be had to display content items 122 with relatively high engagement components.

### Flowchart

FIG. 6 is a flowchart for throttling content item sources 124, in an example embodiment. The flowchart may be implemented according to any of a variety of example systems and methods disclosed herein or as may be suitable for implementing the flowchart.

At operation 600, the feed mixer 108 receives a request to generate the stream 200 for display on a user interface of a user device associated with a member of the social networking system 100. The request may stem from the application logic layer 103 or any other appropriate component of the system 100.

At operation 602, the feed mixer 108 transmits a command to the content item sources 124 to individually generate a ranked list 206 of content items 122 for display to the member.

At operation 604, asynchronous with the operations 600 and 602, the feed mixer 108 determines if a predetermined time has elapsed for determining the output quality metric for any one or more of the content item sources 124. If so, the feed mixer 108 proceeds to operation 608 to determine the output quality metric for the associated content item source 124. If not, the feed mixer 108 proceeds to operation 606. Thus, the feed mixer periodically determines the output quality metric for each content item source 124 periodically and utilizes the output quality metric for the ranked list 206 output by the content item source 124 until a new output quality metric is periodically determined. In an example, upon the output quality metric of a content item source violating a minimum quality metric, none of the content items 122 of an associated ranked list 206 are eligible for output if the output quality metric violates a minimum quality metric. In such an example, the feed mixer 108 is configured to periodically make at least some of the content items 122 of the associated ranked list 206 eligible for output to determine the output quality metric for the content item source 124.

In an example, different output quality metrics are determined for different circumstances, for instance between different types of user devices on which the content items 122 are to be displayed. Thus, in an example, the content item sources 124 generate content items according to a first schema for a first user device platform and a second schema for a second user device platform, the first schema different than the second schema. The feed mixer 108 is configure to determine, for each of the content item sources 124, a first schema output quality metric based on content items 122 output according to the first schema and a second schema output quality metric based on content items output according to the second schema.

At operation 606, the feed mixer 108 also determines if an event has occurred for any one or more of the content item sources 124 that should result in a new output quality metric being determined for the content item source 124, as disclosed herein. In such examples, the event may be an update to the content item source 124 or any other event that may tend to change the output from the content item source 124. The determination of the event may be that the event has occurred at a predetermined time in the past, e.g., that the an update occurred one week previously and now there is likely enough activity data 118 for the content items 122 provided by the content item source 124 to provide a useful output quality metric. Alternatively, the determination that the event has occurred may result in the starting of a delay to allow activity data 118 to be accrued before proceeding to operation 608.

At operation 608, the feed mixer 108 determines the output quality metric for the content item source 124 that either met the predetermined time condition at operation 604 or the event condition at operation 606. As disclosed herein, the output quality metric is determined based on activity data related to actions 118 accessed from an electronic data storage 114 related to content items 122 previously output by a respective content item source 124, wherein each of the plurality of content item sources 124 are configured to output a ranked list 206 of content items 122 stored in the electronic data storage according to a ranking schema different for each of the content item sources, wherein the electronic data is further configured to store content items 122 as provided by the plurality of content item sources 124. If multiple content item sources 124 met one or both of the conditions concurrently then the feed mixer 108 may separately determine the output quality metric for each of the content item sources 124. The output quality metric as determined is then utilized by the feed mixer 108 at operation 610 while the feed mixer 108 also returns to operation 604 to continue to conditionally determine updated output quality metrics.

In an example, for each of the ranked lists 206, the feed mixer determines the number of content items of the ranked list 206 eligible for output to the first user device platform according to the first output quality metric and the number of content items of the ranked list eligible for output to the second user device platform according to the second output quality metric. In an example, each of the content item sources are configured to generate a first ranked list of content items for the first content item platform and a second ranked list of content item for the second content item platform and the feed mixer determines a first number of content items 122 of the first ranked list 206 eligible for output to the user device and a second number of content items 122 of the second ranked list 206 eligible for output to the user device.

At operation 610, the feed mixer 108 determines, for each of the ranked lists 206, based on the output quality metric of the respective content item source 124, a number of content items 122 of the ranked list 206 eligible for output to a user device. In an example, for each of the ranked lists, the content items eligible for output are the number of highest-ranked content items of the ranked list. In an example, the number of content items eligible for output from each of the ranked lists are proportional to the output quality metric of the associated content item source. In an example, none of the content items of a ranked list are eligible for output if the output quality metric violates a minimum quality metric. In an example, all of the content items of a ranked list are eligible for output if the output quality metric exceeds a standard quality metric.

At operation 612, the feed mixer 108 generates the stream 200 based on the eligible content items 122 from the ranked lists 206. The stream 200 may be generated according to any of the mechanism or methodologies disclosed herein or according to any suitable methodology.

At operation 614, the user interface module 102 outputs content items 122 from the stream 200 for display on a user interface 204 according to the eligible content items 122 of the ranked lists 206.

### System

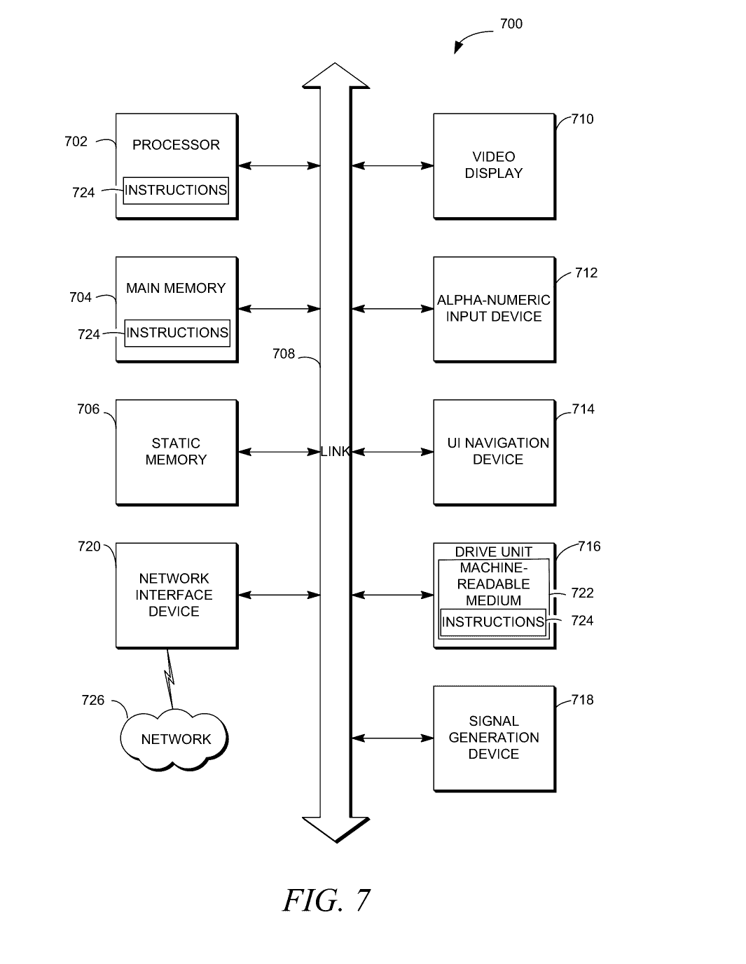

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, the machine 700 may implement the social network system 100 and the features included and described therein. The machine 700 thus describes specific hardware configurations on which the social network system 100 may be implemented and provided to users of the social network system 100.

FIG. 7 shows a diagrammatic representation of the machine 700 in the example form of a computer system and within which instructions 724 (e.g., software) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
determining, with a processor, for each of a plurality of processor-implemented content item sources, an output quality metric based on activity data related to actions accessed from an electronic data storage related to content items previously output by a respective content item source, wherein each of the plurality of content item sources are configured to output a ranked list of content items stored in the electronic data storage according to a ranking schema different for each of the content item sources, wherein the electronic data is further configured to store content items as provided by the plurality of content item sources;
determining, with the processor, for each of the ranked lists, based on the output quality metric of the respective content item source, a number of content items of the ranked list eligible for output to a user device; and
outputting, via a network interface, content items for display on a user interface according to the eligible content items of the ranked lists.

2. The method of claim 1, wherein, for each of the ranked lists, the content items eligible for output are the number of highest-ranked content items of the ranked list.

3. The method of claim 1, wherein the number of content items eligible for output from each of the ranked lists are proportional to the output quality metric of the associated content item source.

4. The method of claim 3, wherein none of the content items of a ranked list are eligible for output if the output quality metric violates a minimum quality metric.

5. The method of claim 3, wherein all of the content items of a ranked list are eligible for output if the output quality metric exceeds a standard quality metric.

6. The method of claim 1, further comprising determining, with the processor, the output quality metric for each content item source periodically and utilize the output quality metric for the ranked list output by the content item source until a new output quality metric is periodically determined.

7. The method of claim 6:
wherein, upon the output quality metric of a content item source violating a minimum quality metric, none of the content items of an associated ranked list are eligible for output if the output quality metric violates a minimum quality metric; and
wherein the processor is configured to periodically make at least some of the content items of the associated ranked list eligible for output to determine the output quality metric for the content item source.

8. A computer readable medium, storing instructions which, when executed on a processor, cause the processor to perform operations comprising:
determine, for each of a plurality of processor-implemented content item sources, an output quality metric based on activity data related to actions accessed from an electronic data storage related to content items previously output by a respective content item source, wherein each of the plurality of content item sources are configured to output a ranked list of content items stored in the electronic data storage according to a ranking schema different for each of the content item sources, wherein the electronic data is further configured to store content items as provided by the plurality of content item sources;
determine, for each of the ranked lists, based on the output quality metric of the respective content item source, a number of content items of the ranked list eligible for output to a user device; and
output, via a network interface, content items for display on a user interface according to the eligible content items of the ranked lists.

9. The computer readable medium of claim 8, wherein, for each of the ranked lists, the content items eligible for output are the number of highest-ranked content items of the ranked list.

10. The computer readable medium of claim 8, wherein the number of content items eligible for output from each of the ranked lists are proportional to the output quality metric of the associated content item source.

11. The computer readable medium of claim 10, wherein none of the content items of a ranked list are eligible for output if the output quality metric violates a minimum quality metric.

12. The computer readable medium of claim 10, wherein all of the content items of a ranked list are eligible for output if the output quality metric exceeds a standard quality metric.

13. The computer readable medium of claim 8, further comprising instructions to determine the output quality metric for each content item source periodically and utilize the output quality metric for the ranked list output by the content item source until a new output quality metric is periodically determined.

14. The computer readable medium of claim 13:
wherein, upon the output quality metric of a content item source violating a minimum quality metric, none of the content items of an associated ranked list are eligible for output if the output quality metric violates a minimum quality metric; and
wherein the content item provider is configured to periodically make at least some of the content items of the associated ranked list eligible for output to determine the output quality metric for the content item source.

15. A system, comprising:
A computer readable medium, storing instructions which, when executed on a processor, cause the processor to perform operations comprising:
determine, for each of a plurality of processor-implemented content item sources, an output quality metric based on activity data related to actions accessed from an electronic data storage related to content items previously output by a respective content item source, wherein each of the plurality of content item sources are configured to output a ranked list of content items stored in the electronic data storage according to a ranking schema different for each of the content item sources, wherein the electronic data is further configured to store content items as provided by the plurality of content item sources;
determine, for each of the ranked lists, based on the output quality metric of the respective content item source, a number of content items of the ranked list eligible for output to a user device; and
output, via a network interface, content items for display on a user interface according to the eligible content items of the ranked lists.

16. The system of claim 15, wherein, for each of the ranked lists, the content items eligible for output are the number of highest-ranked content items of the ranked list.

17. The system of claim 15, wherein the number of content items eligible for output from each of the ranked lists are proportional to the output quality metric of the associated content item source.

18. The system of claim 17, wherein none of the content items of a ranked list are eligible for output if the output quality metric violates a minimum quality metric.

19. The system of claim 17, wherein all of the content items of a ranked list are eligible for output if the output quality metric exceeds a standard quality metric.

20. The system of claim 15, further comprising the processor and the network interface.
